(19) United States
(12) Patent Application Publication
(10) Pub. No.: US 2025/0307918 A1
(43) Pub. Date: Oct. 2, 2025

(54) SYSTEM, METHOD AND APPARATUS FOR PROVIDING USER CONTROLLED REPAYMENT

(71) Applicant: Affirm, Inc., San Francisco, CA (US)

(72) Inventor: Aya Joldassova, El Cerrito, CA (US)

(21) Appl. No.: 18/623,492

(22) Filed: Apr. 1, 2024

(51) Int. Cl. G06Q 40/03; G06Q 20/08

(52) U.S. Cl. CPC G06Q 40/03; G06Q 20/085

(57) ABSTRACT

A method for providing an interface for user controlled loan repayment may include receiving, from a remote device of a customer, a request to initiate a modification activity with respect to a loan, determining a list of modification activities applicable to the loan and the customer, the list of modification activities including a first modification activity and a second modification activity, wherein at least one of the first modification activity or the second modification activity includes a request to change repayment parameters associated with the loan, providing instructions to the remote device to display the list of modification activities, receiving a selected modification activity from the remote device, and recording updated loan terms based on the selected modification activity.

### TECHNICAL FIELD

Example embodiments generally relate to financial industry technologies and, in particular, relate to apparatuses, systems, and methods for enabling consumers to control numerous aspects of the loan repayment process.

### BACKGROUND

The financial industry is comprised of many thousands of customers, vendors, lenders, borrowers, and other role players that all interact in various ways to enable customers to ultimately have access to goods and services provided by the vendors. Credit and debit transactions have long been a way that individuals have managed point of sale transactions to ensure relatively seamless transfer of funds from customers, or on their behalf, to vendors for relatively routine or small transactions. Meanwhile, obtaining a loan from a bank has long been the most common way of obtaining financing for non-routine or larger transactions. More recently, installment loans have become a popular option.

In many cases, a customer may interact with a vendor or lender to work through a transaction that ultimately provides the vendor with the necessary funds to complete the transaction. For typical purchases for which financing is desired using online resources, it is normally the case that the entire cart or transaction amount is financed according to a single financing offer, which could be a selected one of multiple offers. Thus, when the customer selects a financing offer, the details of the offer itself are typically fixed and not able to be modified to any significant degree thereafter. Moreover, the interaction between customer and the financing entity is typically monolithic in nature, and is rigidly controlled by the structure of the web interface provided by the financing entity. As such, customers have very little ability to control the substantive activities associated with processing financed transactions after the fact.

Customers would prefer to have better control of the terms of their financing, and particularly with respect to repayment options. Thus, it may be desirable to define more flexible interfaces and processing methods for making repayments associated financing.

### BRIEF SUMMARY OF SOME EXAMPLES

Accordingly, some example embodiments may enable the provision of technical means by which to provide a foundation for enabling improved repayment options for customers after the financing transaction has been completed.

In an example embodiment, a method for providing an interface for user controlled loan repayment may be provided. The method may include receiving, from a remote device of a customer, a request to initiate a modification activity with respect to a loan, determining a list of modification activities applicable to the loan and the customer, the list of modification activities including a first modification activity and a second modification activity, wherein at least one of the first modification activity or the second modification activity includes a request to change repayment parameters associated with the loan, providing instructions to the remote device to display the list of modification activities, receiving a selected modification activity from the remote device, and recording updated loan terms based on the selected modification activity.

In another example embodiment, an apparatus for providing an interface for user controlled loan repayment may be provided. The apparatus may include processing circuitry configured for receiving, from a remote device of a customer, a request to initiate a modification activity with respect to a loan, determining a list of modification activities applicable to the loan and the customer, the list of modification activities including a first modification activity and a second modification activity, wherein at least one of the first modification activity or the second modification activity includes a request to change repayment parameters associated with the loan, providing instructions to the remote device to display the list of modification activities, receiving a selected modification activity from the remote device, and recording updated loan terms based on the selected modification activity.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a functional block diagram of a system for providing a flexible repayment interface in association with making repayments associated with a financed transaction according to an example embodiment;

FIG. 2 illustrates a functional block diagram of a payments platform according to an example embodiment;

FIG. 3 illustrates a control flow diagram showing an example of communications and activities associated with the payments platform operating in accordance with an example embodiment;

FIG. 4 illustrates a control flow diagram showing an example of communications and activities associated with the payments platform enabling user controlled loan repayment in accordance with an example embodiment;

FIG. 5 illustrates a web page showing an interface for selecting a modification activity in accordance with an example embodiment;

FIG. 6 illustrates a web page showing an interface for bundling loans or changing payment terms in accordance with an example embodiment;

FIG. 7 illustrates a web page showing an interface for bundling loans or changing payment terms in accordance with another example embodiment;

FIG. 8 illustrates a web page for selecting a loan from which to unbundle items for a refund in accordance with an example embodiment;

FIG. 9 illustrates a web page for requesting specific adjustments to loan terms in accordance with an example embodiment; and

FIG. 10 illustrates a block diagram of a method for providing user controlled loan repayment in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other. Additionally, when the term “data” is used, it should be appreciated that the data may in some cases include simply data or a particular type of data generated based on operation of algorithms and computational services, or, in some cases, the data may actually provide computations, results, algorithms and/or the like that are provided as services.

As used in herein, the term “module” is intended to include a computer-related entity, such as but not limited to hardware, firmware, or a combination of hardware and software (i.e., hardware being configured in a particular way by software being executed thereon). For example, a module may be, but is not limited to being, a process running on a processor, a processor (or processors), an object, an executable, a thread of execution, and/or a computer. By way of example, both an application running on a computing device and/or the computing device can be a module. One or more modules can reside within a process and/or thread of execution and a module may be localized on one computer and/or distributed between two or more computers. In addition, these components can execute from various computer readable media having various data structures stored thereon. The modules may communicate by way of local and/or remote processes such as in accordance with a signal having one or more data packets, such as data from one module interacting with another module in a local system, distributed system, and/or across a network such as the Internet with other systems by way of the signal. Each respective module may perform one or more functions that will be described in greater detail herein. However, it should be appreciated that although this example is described in terms of separate modules corresponding to various functions performed, some examples may not necessarily utilize modular architectures for employment of the respective different functions. Thus, for example, code may be shared between different modules, or the processing circuitry itself may be configured to perform all of the functions described as being associated with the modules described herein. Furthermore, in the context of this disclosure, the term “module” should not be understood as a nonce word to identify any generic means for performing functionalities of the respective modules. Instead, the term “module” should be understood to be a modular component that is specifically configured in, or can be operably coupled to, the processing circuitry to modify the behavior and/or capability of the processing circuitry based on the hardware and/or software that is added to or otherwise operably coupled to the processing circuitry to configure the processing circuitry accordingly.

As noted above, the typical repayment process is rigidly fixed, and cannot be modified much (if at all) once the loan terms are agreed upon when the transaction forming the basis for a loan is completed. This rigidity may be disappointing or annoying, although tolerable, in almost all cases. However, in some situations, the rigidity may extend beyond disappointment and annoyance to reach levels of frustration or even anger that can damage relationships with customers. In this regard, for example, if the customer submits a refund for returned goods, the requirement to make payments may continue for the entire period that the product return is being processed. Similarly, products ordered at the same time, but delivered at different times that were otherwise part of the same transaction, may cause the customer to make payments on products not received, which may be difficult to swallow. Moreover, when multiple transactions are involved, different repayment schedules and terms may complicate the overall repayment environment in what seems like an unnecessary way to the customer. Given the popularity of installment loans, which may in many cases provide financing without compounding interest rates (or any interest charged in some cases), some customers may prefer to have the option to use a payment method that either is or at least is convertible to an installment loan at checkout for online purchases. However, whether obtaining financing in the form of an installment loan or a conventional interest bearing loan, customers would nevertheless appreciate an opportunity to simply the interface with the lender to avoid having multiple different payment due dates and terms, which complicate the repayment scenario.

Accordingly, customers would prefer a technical solution that provides a user controlled repayment experience in which the user has more control to set the cadence and/or terms for repayment of loans (potentially of different types), based on a variety of factors that may include (without limitation) income, desired repayment date, desired repayment cadence, and the ability to pause payments in certain situations and unbundle loans or products, when appropriate. Example embodiments may provide a technical means by which to handle the scenarios described above while preserving the opportunity for mutual satisfaction of all parties involved. In this regard, example embodiments provide a user interface, and a processing algorithm for employing the same, that enables the customer to provide significant control over the repayment paradigm. The ability to give customers control over the repayment paradigm introduces a great deal of flexibility into the loan repayment process both for the lender and for the customer (i.e., borrower) that may drive satisfaction, loan volume and loyalty amongst all parties.

By employing example embodiments, not only can customers have the freedom to control their payments, but they may be able to ensure they are not making payments for products they have returned, never received, or have not yet received. This flexibility may remove a certain amount of transactional friction, which may itself drive additional sales and satisfaction for both customers and merchants when customers are actively engaging a merchant to purchase a product or service. Thus, a win-win situation is created for lenders, customers and merchants and, in many cases, the improvement may be accomplished without any need for the merchants or lenders to necessarily modify their web interfaces directly or otherwise alter the workflows associated with their websites. The lender (or a facilitation agent associated therewith) may provide the flexibility in repayment in the form of an upgraded user interface that may integrate with or otherwise enable payment that seamlessly works with the merchants' websites, but also does not require any overhaul of the lender's own websites.

Some example embodiments described herein provide for a payments platform that can be utilized in connection with a repayment facilitator instantiated at an apparatus comprising configurable processing circuitry. The processing circuitry may be configured to execute various processing functions on financial data using the techniques described herein. The payments platform may, for example, be configured to provide a way to enable customers to manage repayment in a more flexible way that gives customers greater flexibility to choose between different repayment cadence and/or term, while enabling loans/products to be bundled or unbundled, and further ensuring that products not in possession of the customer are not being paid for until the status of such products has been resolved. The increased flexibility provided to customers may translate into more access to payment options, more active customers, and better conversion rates for merchants and lenders.

Example embodiments may be employed in connection with underwriting decisions made prior to the customer's arrival at checkout or for decisions made at time of purchase. In relation to underwriting decisions, macroeconomic conditions and seasonality may have an impact on the business of a financial institution or organization that offers the financing options described herein. In response to these factors, and various tuning efforts that may normally be employed, a transactional financing model may utilize all inputs and factors to make a financing extension decision (i.e., whether to extend financing to the user to pay for a transaction) for a customer with respect to a loan associated with one or more items associated with a transaction. In this regard, the transactional financing model may determine an amount of financing to offer to the customer (or user) based on the credit score of the user, the identity of the user or merchant, and numerous other conventional factors that may or may not include specific records of past and recent transactions with a particular company in order to make the financing decision. The loan terms for the financing extension decision may, when accepted and used to form the basis of financing the transaction, then transition into a loan on which repayments are made in association with the original terms of the loan. Modifications to that process may then be accomplished using example embodiments.

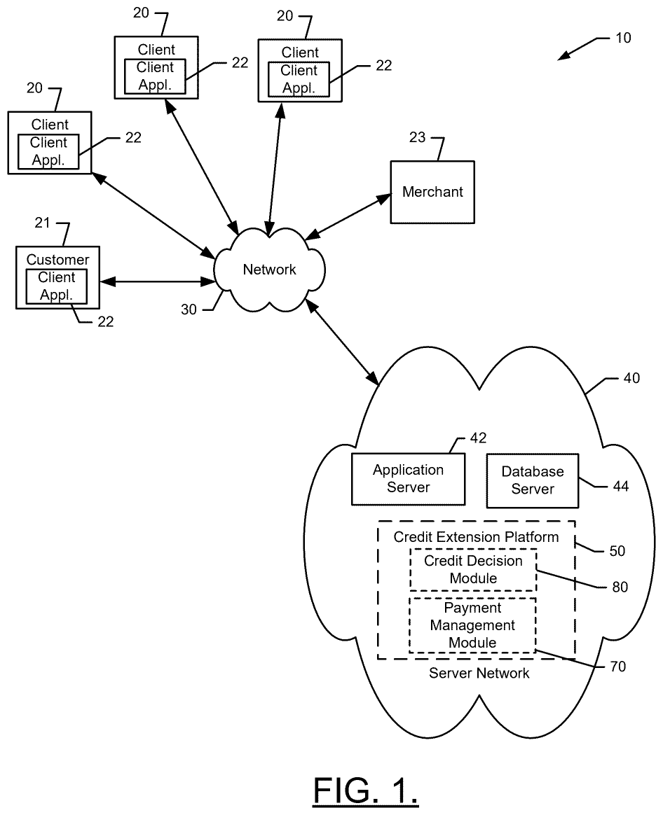

Thus, an example embodiment of the invention will now be described in reference to FIG. 1, which illustrates an example system in which an embodiment of the present invention may be employed. As shown in FIG. 1, a payments management system 10 according to an example embodiment may include one or more client devices (e.g., clients 20). Notably, although FIG. 1 illustrates three clients 20, it should be appreciated that a single client or many more clients 20 may be included in some embodiments and thus, the three clients 20 of FIG. 1 are simply used to illustrate a potential for a multiplicity of clients 20 and the number of clients 20 is in no way limiting to other example embodiments. In this regard, example embodiments are scalable to inclusion of any number of clients 20 being tied into the system 10. Furthermore, in some cases, some embodiments may be practiced on a single client without any connection to the system 10.

The clients 20 may, in some cases, each be associated with a single computer or computing device that is capable of executing software programmed to implement example embodiments. Thus, in some embodiments, one or more of the clients 20 may be associated with an organization (e.g., a merchant company) and may be located in different business units, branch offices, or other locations. In other cases, the clients 20 may be associated with individual users (i.e., customers) that may wish to interact with other clients 20 and/or a financial institution or entity. In general, the clients 20 may be terminals or platform entities that are capable of executing example embodiments, and there could be as few as one, or a host of such terminals or entities. In the present example, one of the clients 20 may be specifically associated with a customer 21 and is therefore labeled as such. Meanwhile, another of the clients 20 may be associated with a vendor or merchant. However, in order to account for the possibility that the vendor/merchant may have no prior relationship with the system 10 (or the company or institution that instantiates the system 10), FIG. 1 illustrates more generally a merchant 23, which is a vendor/merchant that has its own computer, computing device, server, point of sale checkout device, or other communication platform capable of interacting with the system 10.

Each one of the clients 20 (including the customer 21, and in some cases also the merchant 23) may include one or more instances of a communication device such as, for example, a computing device (e.g., a computer, a server, a network access terminal, a personal digital assistant (PDA), radio equipment, cellular phone, smart phone, or the like) capable of communication with a network 30. As such, for example, each one of the clients 20 may include (or otherwise have access to) memory for storing instructions or applications for the performance of various functions and a corresponding processor for executing stored instructions or applications. Each one of the clients 20 may also include software and/or corresponding hardware for enabling the performance of the respective functions of the clients 20 as described below. In an example embodiment, the clients 20 may include or be capable of executing a client application 22 configured to operate in accordance with an example embodiment of the present invention. In this regard, for example, the client application 22 may include software for enabling a respective one of the clients 20 to communicate with the network 30 for requesting and/or receiving information and/or services via the network 30 as described herein. The information or services receivable at the client applications 22 may include deliverable components (e.g., downloadable software to configure the clients 20, or information for consumption/processing at the clients 20). As such, for example, the client application 22 may include corresponding executable instructions for configuring the client 20 to provide corresponding functionalities for sharing, processing and/or utilizing financial data as described in greater detail below.

In an example embodiment, the client application 22 may be embodied as a software module that is used to customize a web browser of the client 20, or to customize a particular interface of the client 20 to tailor the client 20 to communicate with a lender or agent thereof in the manner described herein. The customization may include, for example, modifications to the user interface of the web browser. The client application 22 may therefore include source code capable of altering browser settings, adding user interface items to web pages, or adding to/replacing website content on web pages. In some cases, the client application 22 may have access to browsing history or current/active searches conducted by the client 20.

The network 30 may be a data network, such as one or more instances of a local area network (LAN), a metropolitan area network (MAN), a wide area network (WAN) (e.g., the Internet), and/or the like, which may couple the clients 20 to devices such as processing elements (e.g., personal computers, server computers or the like) and/or databases. Communication between the network 30, the clients 20 and the devices or databases (e.g., servers) to which the clients 20 are coupled may be accomplished by either wireline or wireless communication mechanisms and corresponding communication protocols.

In an example embodiment, devices to which the clients 20 may be coupled via the network 30 may include many different vendors (of which the merchant 23 is one example) and one or more application servers (e.g., application server 42), and/or a database server 44, which together may form respective elements of a server network 40. Although the application server 42 and the database server 44 are each referred to as “servers,” this does not necessarily imply that they are embodied on separate servers or devices. As such, for example, a single server or device may include both entities and the database server 44 could merely be represented by a database or group of databases physically located on the same server or device as the application server 42. The application server 42 and the database server 44 may include hardware and/or software for configuring the application server 42 and the database server 44, respectively, to perform various functions. As such, for example, the application server 42 may include processing logic and memory enabling the application server 42 to access and/or execute stored computer readable instructions for performing various functions.

In an example embodiment, one function that may be provided by the application server 42 may be the provision of access to information and/or services related to payments platform 50, and more particularly relating to facilitating financial computations and calculations related to decisions associated with extensions of financing options (e.g., loans where, for example, the loans may include an installment loan, or other products associated with credit or lending transactions). For example, the application server 42 may be configured to provide (via the payments platform 50) execution of instructions, and storage of information descriptive of events or activities, associated with the payments platform 50 and the execution of a financial computations, calculations and modeling on behalf of a user of the system 10 located at one of the clients 20, or interacting with a user located at one of the clients 20, in real time. In some cases, the financial transaction may include obtaining financing (e.g., conventional loans or installment loans), and the activities associated therewith may include the provision of a loan/product application detailing information required by the lender (and operator of the payments platform 50) to determine whether credit, funds, or other products can be provided to the customer based on information provided in the loan/product application.

In some embodiments, the payments platform 50 may be a technical device, component or module affiliated with the lender or an agent of the lender. Thus, the payments platform 50 may operate under control of the lender or agent of the lender to be a technical means by which to carry out activities under direction of the lender/agent or employees thereof. As such, in some embodiments, the clients 20 may access the payments platform 50 services, and more particularly contact the payments platform 50 online and utilize the services provided thereby. However, it should be appreciated that in other embodiments, an application (e.g., the client application 22) enabling the clients 20 to interact with the payments platform 50 (or components thereof) may be provided from the application server 42 (e.g., via download over the network 30) to one or more of the clients 20 to enable recipient clients 20 to instantiate an instance of the client application 22 for local operation such that the payments platform 50 may be a distributor of software enabling individual users to utilize the payments platform 50. Alternatively, another distributor of the software may provide the client 20 with the client application 22, and the payments platform 50 may communicate with the client 20 (via the client application 22) after such download. In some examples, the client application 22 may be obtained from a web application store (e.g., Google's Chrome Web Store, or other similar web stores at which applications and browser extensions may be obtained).

In an example embodiment, the client application 22 may therefore include application programming interfaces (APIs) and other web interfaces to enable the client 20 to conduct operations as described herein via the payments platform 50 and/or via modification to websites and/or web pages associated with the merchant 23. The client application 22 may include source code for modifying the websites and/or web pages, and may also include links to a series of control consoles or web pages including a landing page, onboarding services, activity feed, account settings (e.g., user profile information), transaction management services, payment management services and the like in cooperation with a service application that may be executed at the payments platform 50. Thus, for example, the client application 22 may enable the user or operator (e.g., the customer 21) to connect with the payments platform 50 to articulate and submit queries, make financing requests, initiate and pay for transactions using funds associated with a financing request, and/or the like using the payments platform 50 in association with an account (e.g., a user account) that is associated with the customer 21.

In an example embodiment, the application server 42 may include or have access to memory (e.g., internal memory or the database server 44) for storing instructions or applications for the performance of various functions and a corresponding processor for executing stored instructions or applications. For example, the memory may store an instance of the payments platform 50 configured to operate in accordance with an example embodiment of the present invention. In this regard, for example, the payments platform 50 may include software for enabling the application server 42 to communicate with the network 30 and/or the clients 20 for the provision and/or receipt of information associated with performing activities as described herein. Moreover, in some embodiments, the application server 42 may include or otherwise be in communication with an access terminal such as any one of the clients 20 (e.g., a computer including a user interface) via which individual operators or managers of the entity associated with the facilitation agent may interact with, configure or otherwise maintain the payments platform 50. Thus, it should be appreciated that the functions of the payments platform 50 can be conducted via client-server based interactions involving communications between clients 20 and the server network 40.

As such, the environment of FIG. 1 illustrates an example in which provision of content and information associated with the financial industry may be accomplished by a particular entity (namely the payments platform 50 residing at the application server 42 or at one of the clients 20) via interaction with the client application 22. Thus, the payments platform 50 may be configured to handle provision of content and information that are secured as appropriate for the individuals or organizations involved and credentials of individuals or organizations attempting to utilize the tools provided herein may be managed by digital rights management services or other authentication and security services or protocols that are outside the scope of this disclosure.

As noted above, the payments platform 50 may operate to enable the user associated with a given one of the clients 20 to setup an account (i.e., the user account 160) with an entity that operates the payments platform 50. After account setup, the user may initiate transactions with various vendors (including merchant 23) and fund the transactions via credit extended by the entity. Notably, account setup may occur prior to the user attempting to initiate any particular transaction, or may occur while the user is in the process of conducting a particular transaction. Thus, for example, the user may already have the user account 160 prior to conducting transactions, or the user may setup the user account 160 while conducting a transaction (or on the way to conducting a transaction).

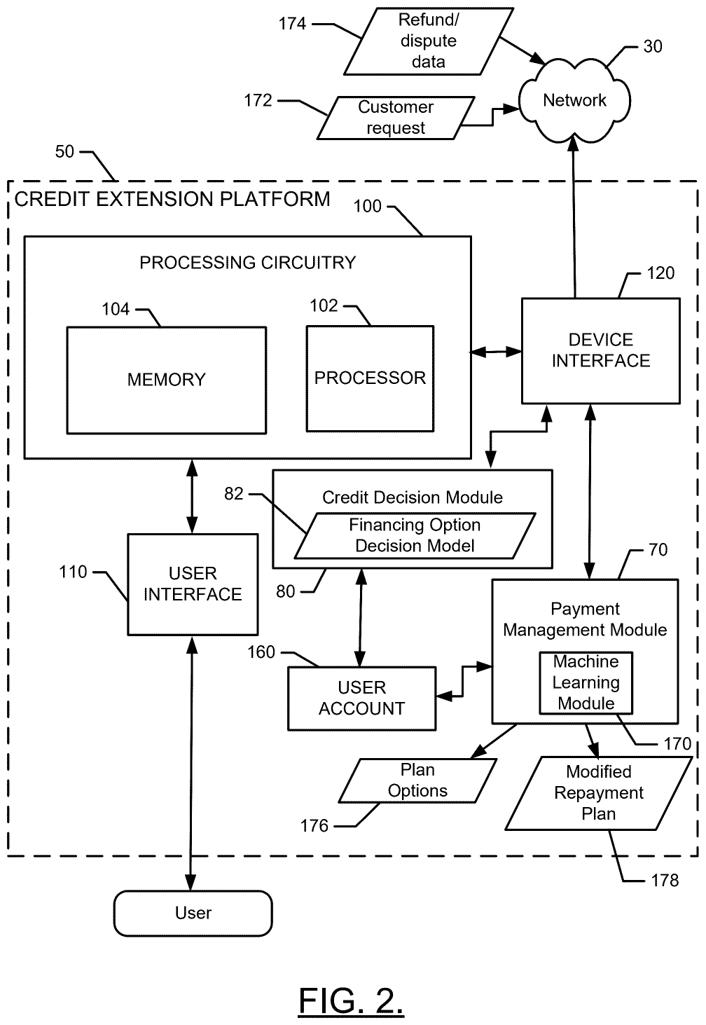

In an example embodiment, the payments platform 50 may enable the user to request an extension of credit, or accept an offer of the extension of credit, in connection with a transaction where the type of financing associated with the extension of credit may include, for example, a buy now, pay later (BNPL) or installment loan, or a conventional interest-bearing loan. To accomplish this, the payments platform 50 of some example embodiments may conduct determinations regarding financing so that, for example, one or more payment options may be provided to the user at checkout (or on the way to checkout) via the browser extension (i.e., via the client application 22). As an example, at or prior to checkout (e.g., including in response to search activities, or browsing of web pages of the merchant 23), the payments platform 50 may make a determination as to the creditworthiness of the user and provide information indicating a financing offer (or credit offer) to the user that can be accepted either on the way to checkout or at checkout. The financing offer may be specific to, and generated based on, the merchant 23 (as described in greater detail in reference to FIG. 2 below), the customer 21, or various other factors.

In some example embodiments, a decision model may be provided to guide the ability of the payments platform 50 to make a financing decision regarding each individual customer (e.g., the customer 21) and/or vendor (e.g., the merchant 23). Example embodiments may also employ machine learning with respect to many different data points associated with the user, the merchant, the type of transaction, or many other pieces of relevant information. The use of machine learning may be tailored to providing the user with financing offers that include repayment options that are most likely to be useful to the user as described in greater detail below. The repayment options selected via machine learning may then be presented to the user for selection of the desired or best option available.

In some cases, for example, the client application 22 may be used to engage (e.g., via a website and corresponding APIs) with the payments platform 50 to select individually available terms associated with a loan product that the user has an interest in employing for purchasing goods or services in connection with an online transaction. The payments platform 50 may then be leveraged to perform the analysis described above to determine which financing offers to present to the user for use at checkout. The financing offer may be accepted and a virtual card, or other purchasing vehicle, may be issued to the customer 21. At final checkout, the user (i.e., customer 21) may then be enabled to finalize the transaction using the virtual card or other purchasing vehicle.

In some embodiments, the payments platform 50 may effectively conduct a pre-approval of the customer 21 for a financing offer that is associated with (or determined at least in part based on) the creditworthiness of the customer 21. In some cases, the identity of the merchant or the products being financed may also influence details of the financing offer. This approval process may also be conducted in real time at checkout (virtual or physical). The customer 21 may, prior to checkout and/or at checkout, be made aware of the financing offer and various terms associated therewith and, by accepting the financing offer, be issued the virtual card. The virtual card may then be used at checkout to obtain the goods or services being purchased from the merchant 23 with funds being provided (directly or indirectly) to the merchant 23 by the entity associated with the payments platform 50, and a loan (e.g., an installment loan) is then instantiated between the user and the entity in association with the user account 160.

As an alternative to the virtual card, as noted above, another purchasing vehicle may be employed. Alternative purchasing vehicles may take numerous forms. One example embodiment may instantiate the alternative purchasing vehicle in the form of an API that directly interfaces with a backend payment processing system of the merchant 23 to provide one-click checkout for the customer 21. In this regard, for example, the merchant 23 and the entity associated with the system 10 may be partners, or have a pre-existing agreement, that enables the merchant 23 to directly obtain payment from the entity responsive to extension of credit by the entity to the customer 21 based on the pre-approval of the customer 21 for the financing offer. The cart of the customer 21 may, e.g., with a single button or selectable interface element, be totaled and transferred to an installment loan with the entity, payment may be received by the merchant 23, and shipment initiated to the customer 21 with a single click or single interface element selection.

Regardless of how the queries, calculations or modeling activities are initiated, the payments platform 50 of FIG. 1 may be used to manage execution of such activities. Each of these activities may have its own respective timing and calculations and communications that are facilitated by the payments platform 50 and various components of the payments platform 50 may be conducted in parallel. The components, which may be functional modules that operate via API or function calls to respective segmented platforms or a monolith or other collection of rules, policies, instructions, or the like. However, as noted above, the payments platform may be augmented to enable the provision of interfaces to enable the customer 21 to select options for tailoring repayment, and for pausing payments in certain qualifying circumstances.

The activities associated with tailoring repayment options may be accomplished via a payment management module 70, and activities described above that are associated with making financing decisions may be accomplished via a financing decision module 80. These modules will be discussed in more detail below and in reference to FIG. 2.

FIG. 2 shows certain elements of an apparatus for provision of the payments platform 50 or other processing circuitry according to an example embodiment. The apparatus of FIG. 2 may be employed, for example, as the payments platform 50 itself operating at, for example, a network device, server, proxy, or the like (e.g., the application server 42 of FIG. 1)). Alternatively, embodiments may be employed on a combination of devices (e.g., in distributed fashion on a device (e.g., a computer) or a variety of other devices/computers that are networked together). Accordingly, some embodiments of the present invention may be embodied wholly at a single device (e.g., the application server 42) or by devices in a client/server relationship (e.g., the application server 42 and one or more clients 20). Thus, although FIG. 2 illustrates the payments platform 50 as including the components shown, it should be appreciated that some of the components may be distributed and not centrally located in some cases. Furthermore, it should be noted that the devices or elements described below may not be mandatory and thus some may be omitted or replaced with others in certain embodiments.

Referring now to FIG. 2, an apparatus for provision of tools, services and/or the like for facilitating decision making regarding extensions of credit, and for providing processing options associated with tailored making of repayments thereafter, is shown. In this regard, the payments platform 50 may be configured to perform analysis, modeling, or other determinations based on the signaling and/or the information provided to determine whether a financial transaction or loan can be underwritten according to a selected type of financing option (e.g., an installment loan or conventional loan) and, if so, what financing offers to extend to the user receiving an affirmative result in such determinations. The apparatus may be an embodiment of the payments platform 50 or a device or component thereof including, for example, the payment management module 70 that may operate in association with the financing decision module 80. As such, configuration of the apparatus as described herein may transform the apparatus into the payments platform 50. In an example embodiment, the apparatus may include or otherwise be in communication with processing circuitry 100 that is configured to perform data processing, application execution and other processing and management services according to an example embodiment of the present invention. In one embodiment, the processing circuitry 100 may include a storage device (e.g., memory 104) and a processor 102 that may be in communication with or otherwise control a user interface 110 and a device interface 120. As such, the processing circuitry 100 may be embodied as a circuit chip (e.g., an integrated circuit chip) configured (e.g., with hardware, software or a combination of hardware and software) to perform operations described herein. However, in some embodiments, the processing circuitry 100 may be embodied as a portion of a server, computer, laptop, workstation or even one of various mobile computing devices. In some embodiments, the processor 102 may be embodied as a central processing unit (CPU) or a graphics processing unit (GPU). In situations where the processing circuitry 100 is embodied as a server or at a remotely located computing device, the user interface 110 may be disposed at another device (e.g., at a computer terminal) that may be in communication with the processing circuitry 100 via the device interface 120 and/or a network (e.g., network 30). Thus, in some cases, the connection of the user to the user interface 110 may actually occur via the network 30.

The user interface 110 may be in communication with the processing circuitry 100 to receive an indication of a user input at the user interface 110 and/or to provide an audible, visual, mechanical or other output to the user. As such, the user interface 110 may include, for example, a keyboard, a mouse, a joystick, a display, a touch screen, a microphone, a speaker, augmented/virtual reality device, or other input/output mechanisms. In embodiments where the apparatus is embodied at a server or other network entity, the user interface 110 may be limited or even eliminated in some cases. Alternatively, the user interface 110 may be remotely located. In some cases, the user interface 110 may be located at one of the clients 20 of FIG. 1.

The device interface 120 may include one or more interface mechanisms for enabling communication with other devices and/or networks. In some cases, the device interface 120 may be any means such as a device or circuitry embodied in either hardware, software, or a combination of hardware and software that is configured to receive and/or transmit data from/to a network (e.g., network 30) and/or any other device or module in communication with the processing circuitry 100. In this regard, the device interface 120 may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods. In situations where the device interface 120 communicates with a network, the network 30 may be any of various examples of wireless or wired communication networks such as, for example, data networks like a Local Area Network (LAN), a Metropolitan Area Network (MAN), and/or a Wide Area Network (WAN), such as the Internet, as described above.

In an example embodiment, the memory 104 may include one or more non-transitory storage or memory devices such as, for example, volatile and/or non-volatile memory that may be either fixed or removable. The memory 104 may be configured to store information, data, applications, instructions or the like for enabling the apparatus to carry out various functions in accordance with example embodiments of the present invention. For example, the memory 104 could be configured to buffer input data for processing by the processor 102. Additionally or alternatively, the memory 104 could be configured to store instructions for execution by the processor 102. As yet another alternative, the memory 104 may include one of a plurality of databases (e.g., database server 44) that may store a variety of files, contents or data sets. Among the contents of the memory 104, applications (e.g., a service application configured to interface with the client application 22) may be stored for execution by the processor 102 in order to carry out the functionality associated with each respective application.

The processor 102 may be embodied in a number of different ways. For example, the processor 102 may be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. In an example embodiment, the processor 102 may be configured to execute instructions stored in the memory 104 or otherwise accessible to the processor 102. As such, whether configured by hardware or software methods, or by a combination thereof, the processor 102 may represent an entity (e.g., physically embodied in circuitry) capable of performing operations according to embodiments of the present invention while configured accordingly. Thus, for example, when the processor 102 is embodied as an ASIC, FPGA or the like, the processor 102 may be specifically configured hardware for conducting the operations described herein. Alternatively, as another example, when the processor 102 is embodied as an executor of software instructions, the instructions may specifically configure the processor 102 to perform the operations described herein.

In an example embodiment, the processor 102 (or the processing circuitry 100) may be embodied as, include or otherwise control the payment management module 70 an the financing decision module 80, each of which may be any means such as a device or circuitry operating in accordance with software or otherwise embodied in hardware or a combination of hardware and software (e.g., processor 102 operating under software control, the processor 102 embodied as an ASIC or FPGA specifically configured to perform the operations described herein, or a combination thereof) thereby configuring the device or circuitry to perform the corresponding functions of the payment management module 70 and the financing decision module 80, respectively, as described below.

The financing decision module 80 may be configured to include tools to facilitate execution of a transactional-based financing decision based on a financing option decision model 82. The tools may be provided in the form of various modules (or submodules) that may be instantiated by configuration of the processing circuitry 100. The financing option decision model 82 may include tables, algorithms and/or the like that define decision making parameters based on the inputs provided thereto. The inputs may include many different signals that may be used to balance risks associated with extending credit to a user (or a device from which a financing request is received that purports to be associated with the user). These signals typically include identity information indicating an identity of the user (which may be provided in connection with a user account 160), and other information enabling a check of a credit score of the user, information descriptive of the transaction itself or items (e.g., a stock-keeping unit (SKU) or other code used to track products at the individual product level), price and other parameters associated with the transaction. However, numerous other signals may also be included that may be used to detect fraud or confirm various aspects of the information noted above or other information that may be useful in making financing decisions. The other signals may include information associated with the current and past transactions between the user and the entity that operates the payments platform 50 and/or any other relationship or other information that may inform the decision making process for selecting the form and structure of the financing offers (including term, repayment schedule, interest (if any), etc.). In this regard, for example, information indicative of most likely preferred options for the user (which may be learned by the machine learning component) may be used. The financing option decision model 82 may also include tables, algorithms and/or the like that enable computation (by the financing decision module 80) of a borrowing limit that is suggested for the customer 21 and/or specific financing offers (e.g., including a term or details regarding the number, size and pace of repayments that are to be made) based on all of the other inputs received. The borrowing limit given (or suggested) and/or the financing offers made by the financing decision module 80 may therefore be made based on live signaling and the financing option decision model 82.

After one or more financing offers are presented to the user (e.g., customer 21), one of the financing offers may be selected and accepted to form the basis for payment of the merchant (e.g., merchant 23) and the origination of a loan to the user in the amount of the transaction (perhaps less any down payment). Thereafter, repayment of the loan would normally be conducted at the number, size and pace of repayments prescribed for the financing offer accepted/selected, and may be one of many differently sized and paced repayments that the user must make over a period of time for this and other loans of various different terms and types. However, the payment management module 70 may, as noted above, enable the user to pause certain payments, modify the payments, and in some cases even modify terms of loans to consolidate (or bundle) loans to reduce or simplify repayment logistics, or unbundle loans or products/transactions within loans when such unbundling is warranted.

If the customer 21 already has the user account 160, the customer 21 may login or otherwise authenticate himself/herself to obtain access to the user account 160. After one of the financing offers has been accepted (e.g., after a review of disclosures and acceptance of terms), and the user account 160 is associated with the customer 21 (or created for the customer 21 if the customer 21 is new), further interaction with the system may be possible. The creation of the user account 160 may require submission (or confirmation) of information such as the name of the individual associated with the customer 21, billing address, account information for checking, savings or other individual accounts (e.g., bank accounts) from which payments may be extracted, telephone number, etc. In some cases in which the customer 21 already has the user account 160, the customer 21 may simply log in or authenticate within the system to access and utilize the approved financing offer. In any case, financing offer acceptance causes storage of information associated with the loan originated to finance the transaction (e.g., in memory 104) to permit modification or interaction thereafter (again responsive to customer 21 login to the user account 160) to modify aspects of the loan repayment as described herein using the payment management module 70.

In an example embodiment, the payment management module 70 may further include a machine learning module 170 that may facilitate the presentation of options to the user in association with the modifications discussed above. The machine learning module 170 may employ one or more instances of a neural network (e.g., a CNN), a support vector machine (SVM), Bayesian network, logistic regression, logistic classification, decision tree, ensemble classifier or other machine learning model to process inputs received by the machine learning module 170 to generate output options that may be acceptable to the facilitator of the payments platform 50 and may also be attractive to the customer 21 based on information known about the customer 21 via past interactions, or profile information associated with the customer 21 (e.g., via the user account 160 and activities associated therewith).

The machine learning module 170 may be supervised (identifying patterns in raw data upon which inference processes are desired to be performed via training examples) or unsupervised (identifying patterns in raw data upon which inference processes are desired to be performed without training examples). In an example embodiment, the machine learning module 170 may include a neural network of nodes where each node includes input values, a set of weights, and an activation function. The neural network node may calculate the activation function on the input values to produce an output value. The activation function may be a non-linear function computed on the weighted sum of the input values plus an optional constant. Neural network nodes may be connected to each other such that the output of one node is the input of another node. Moreover, neural network nodes may be organized into layers, each layer comprising one or more nodes. The neural network may be trained and update its internal parameters via backpropagation during training. A CNN may be a type of neural network that further adds one or more convolutional filters (e.g., kernels) that operate on the outputs of the preceding neural network layer to produce and output to then next layer. The convolutional filters may have a window in which they operate, which is spatially local. A node of a preceding layer may be connected to a node in the current layer if the node of the preceding layer is within the window. If not within the window, then the nodes are not connected.

In an example embodiment, training may occur via the provision of training data (e.g., training repayment data, etc.) along with target data that includes loan repayment data associated with various repayment models stored in the memory 104 and accessible to the machine learning module 170. Thereafter, when inferences are to be drawn with respect to a new set of data including new loan information to provide an output that is indicative of options for repayment (e.g., cadence, amount, specific payment dates, etc.) training backpropagation may be provided to update the learning. The information provided to the machine learning module 170 in some cases may include a customer request 172 indicating a request to modify repayment terms associated with a loan (or loans), refund/dispute data 174 indicating the identity of a product being returned or whose delivery is disputed, and any other identifying information. Resulting plan options 176 may then be generated for display to the customer 21 and interaction at the client 20 may be initiated to receive selections from the customer with respect to the plan options 176. When selections are made, the machine learning module 170 may quickly determine a modified repayment plan 178, which may be reviewed and accepted by the customer 21 if not already accepted at the plan option stage.

Regardless of the specific form of the machine learning module 170, machine learning may be performed to perform inferences with respect to massively large volumes of data that would take normal computer processing very long periods of time to handle. The machine learning module 170 can handle massive volumes of data, and identify the data pertinent to a given user, within constraints that may be unique to the given user, in the context of mountains of information, within seconds, whereas doing so with conventional processing tools (i.e., without machine learning) would take orders of magnitude longer periods of time. The machine learning module 170 therefore enables an acceleration of the processing needed to conduct processing of data, but also to find deep patterns that are meaningful with respect to providing options that are most likely to be acceptable to the given user within constraints that apply. Thus, for example, the machine learning module 170 may define payment schedule options that are able to tailor the perfect repayment plan for the given user. Information can be inferred such as the given user's payday, preferred payment schedule, preferred payment amounts, preferred payment cadence, etc., and may be used to define options for user selection incorporating these inferences. The dates of ACH transactions from the user account 160, amounts of credits/debits associated therewith, and other clues may all be employed by the machine learning module 170 within this context.

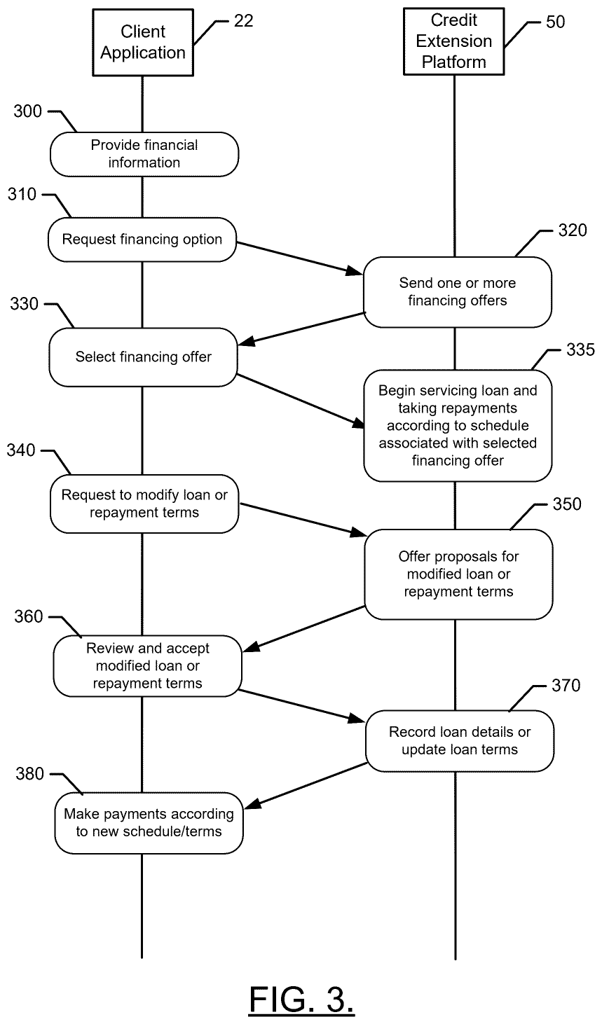

FIG. 3 illustrates an example control flow diagram of an example embodiment. As shown in FIG. 3, an example of the client application 22 at an instance of the customer 21 may provide financial information at operation 300 and provide a request for a financing option at operation 310. The financial information may include identity information for the customer 21, login information for the user account 160, merchant identity information, cart or transaction information, and/or the like. In some cases, operations 300 and 310 may effectively form (or include) a financing application. Thus, the client application 22 may either interface with the financing decision module 80 in real time, or rely on stored information received from the payments platform 50, to request one or more financing offers that may be associated with a transaction (e.g., with a merchant) via a financing application. The payments platform 50 may then use the information provided, as described above, to identify and send one or more financing offers to the customer 21 at operation 320. It can be assumed in this example that the payments platform 50 has approved or pre-approved the customer 21 for each of the financing offers that is sent at operation 320, and therefore also that the financing application is approved. At operation 330, the customer 21 may select one of the financing offers. The selected financing offer may include a given number of payments over a given period of time, or could include conventional loan details like the interest rate and minimum payment amount and/or frequency. At operation 335, the payments platform 50 may undertake normal loan servicing by taking and processing loan repayments according to the schedule associated with the selected financing offer, and this may continue until the loan is fully amortized, or until operation 340 occurs.

At operation 340, the customer 21 may (via the client application 22) request to modify the loan repayment terms. Upon receipt, the payments platform 50 may employ the machine learning module 170 as noted above to provide options or offer proposals for modifying the loan or repayment terms based on the requested modification, and may generate instructions to display the offered proposals at the client application 22 of the customer 21 at operation 350. The modified repayment terms may show the modified amount of payments, adjusted payment date/amount, or other modified loan or repayment terms based on any adjusted loan principal or amount that applies at the current date. Generally, the same number of payments that were defined in the selected financing offer may be retained, but other options may also be presented. After receiving the modified loan or repayment terms, the client application 22 may be used to review and accept the modified loan or repayment terms at operation 360. The payments platform 50 may thereafter record loan details or update loan terms and begin to track performance with respect to, and service, the updated loan at operation 370. At operation 380, the customer 21 may make payments according to the new schedule/terms.

The process of FIG. 3 may generally be followed in some example embodiments. However, some modifications may be made and still be consistent with example embodiments. In this regard, the communications shown in FIG. 3 may happen in real-time via a web browser or internet application, but need not necessarily be so. Communications could alternatively happen via SMS or email, and may be conducted in at any time after the transaction for which the loan is to be obtained. Push messages or notifications could also be used for some messaging, and to follow up on sales, marketing events, or other merchant or facilitator initiatives. Other changes may also be included

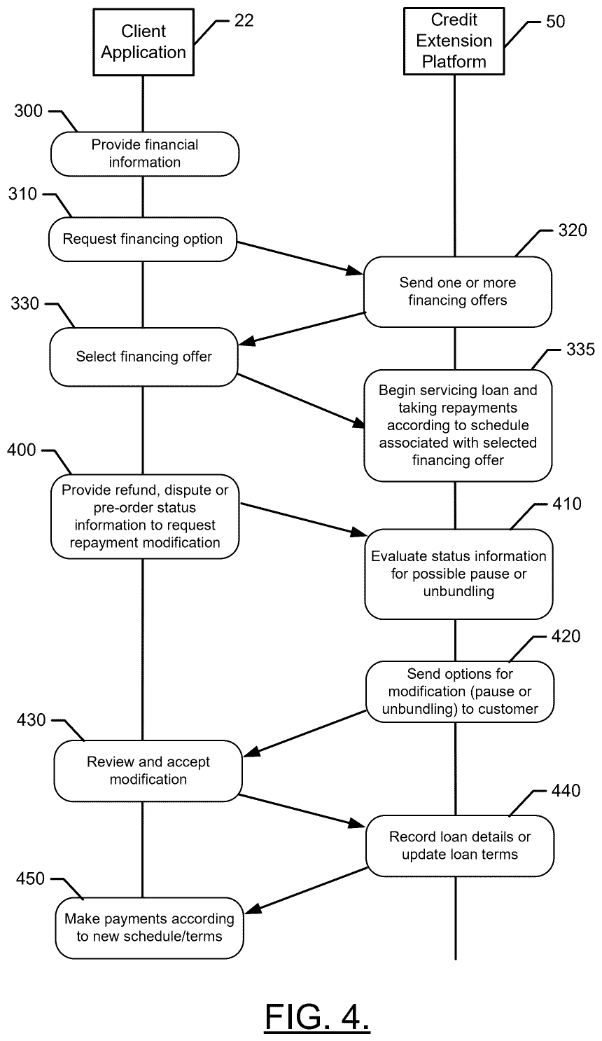

Referring now to FIG. 4, same process flow as described above in relation to FIG. 3 may occur through loan servicing (i.e., operations 300 to 335). However, instead of a generic request to modify repayment characteristics or modify loan terms as noted at operation 340 above, a more specific request to provide refund, dispute or pre-order status information may be sent by the customer 21 as a request for repayment modification at operation 400. The payments platform 50 may then evaluate the status information provided for possible payment modification, pausing, or unbundling at operation 410. Based on this evaluation (which may be performed by the payment management module 70 (with or without assistance from the machine learning module 170), options for modification (e.g., pausing, unbundling, etc.) may be provided to the customer 21 at operation 420. The customer 21 may review and select an option, or otherwise accept the modification proposed at operation 430. Loan details may then be recorded or updated with the changed loan terms at operation 440, and the customer 21 may begin making payments according to a new schedule or new terms at operation 450.

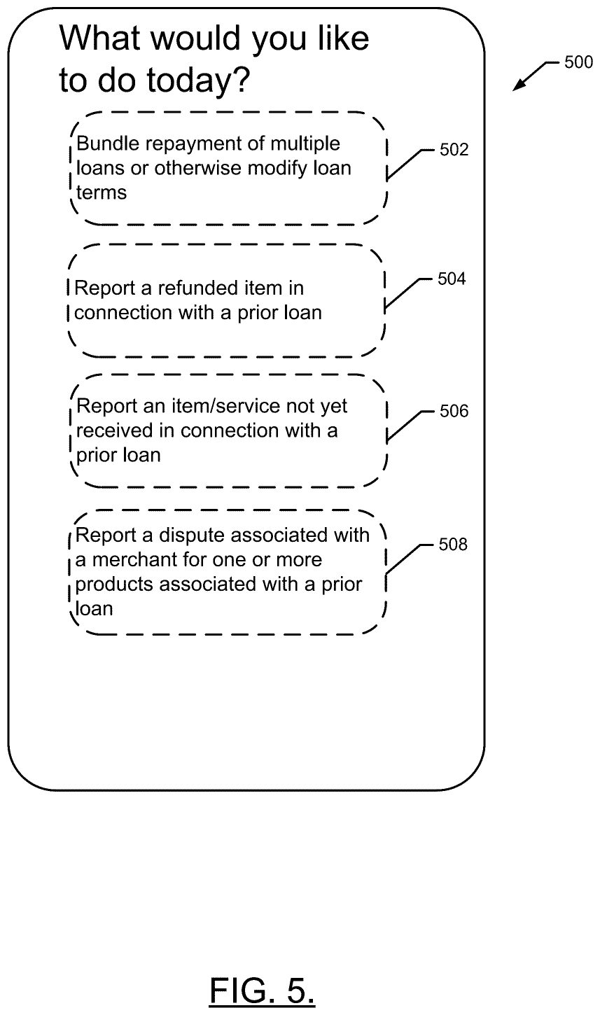

As noted above, the machine learning module 170 may be employed to attempt to tailor user interface options presented to the customer 21 such that the option not only conform to any applicable constraints, but also consider the specific characteristics of the customer 21 to maximize the likelihood that options presented may be acceptable to the customer 21. While the results are therefore often very specific to the customer 21, some example illustrations of control console or web page interface screens are shown in FIGS. 5-9.

FIG. 5 illustrates a web page 500 or smart phone display screen showing activity that may be undertaken by the customer 21 in communication with the payments platform 50 to modify an existing loan in accordance with an example embodiment. In this regard, FIG. 5 shows a plurality of modification activities that may be performed (e.g., a first modification activity 502, a second modification activity 504, a third modification activity 506 and a fourth modification activity 508) displayed on the web page 500. Each of the first, second and third modification activities 502, 504 and 506 is an example of a modification that can be requested by the customer 21 via operation 340 of FIG. 3, or operation 400 of FIG. 4.

In this regard, the first modification activity 502 of this example is a request to bundle repayment of multiple loans or otherwise modify terms for repayment of a loan. The second modification activity 504 is a request to modify a loan based on a refunded item associated with the loan (e.g., to unbundle the corresponding item or loan). The third modification activity 506 is a request to modify a loan based on an item or service associated with the loan not yet being received, and the fourth modification activity 508 is a request to modify a loan based on a dispute with a merchant regarding an item associated with the loan. Notably, other activities or modifications may also be included in some cases. In any case, responsive to selection of one of the modification activities, a corresponding work flow and series of additional screens may be launched.

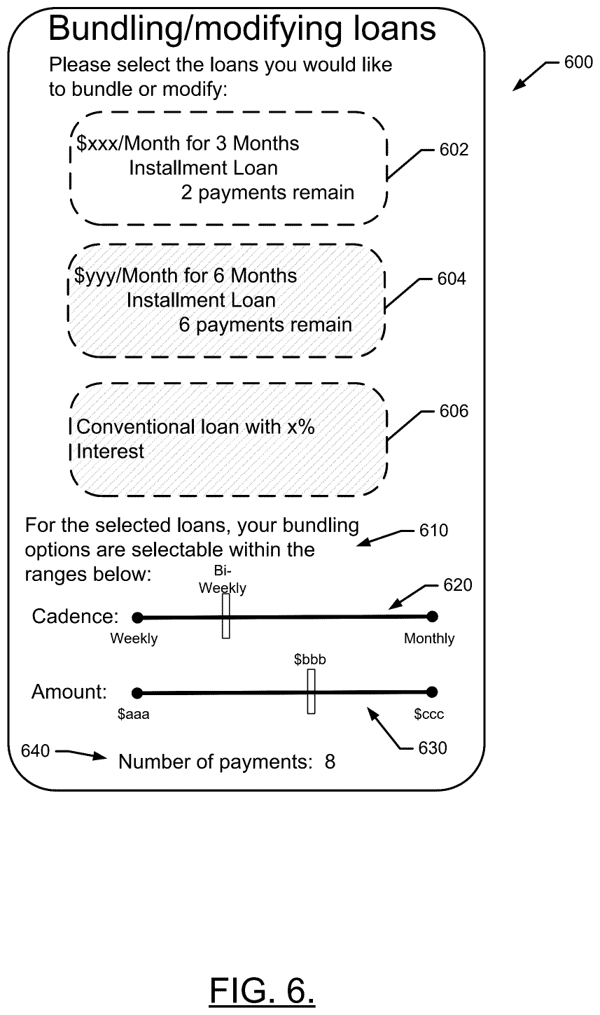

FIG. 6 illustrates a web page 600 that may be displayed responsive to selection of the first modification activity 502 of FIG. 5. The web page 600 may be displayed at the client application 22 of the customer 21 through interaction with the payment management module 70 (e.g., with the machine learning module 170). The web page 600 displays a loan listing for eligible loans that can be bundled, and the loan listing of this example includes a first loan 602, a second loan 604, and a third loan 606. As can be appreciated from FIG. 6, each of the first loan 602, the second loan 604, and the third loan 606 has different terms, and the third loan 606 is also of a different type (i.e., a conventional loan) than the first and second loans 604 and 606 (i.e., installment loans). The customer 21 may wish to consolidate these loans into a single loan having combined payments that are on one schedule rather than multiple schedules.

In the depicted example, the customer 21 has indicated selection of the second loan 604 and the third loan 606 for bundling. A bundling options section 610 may then be generated showing selectable options that the customer 21 may employ for submission of details outlining the modification requested. In this example, a range for the cadence of payments (i.e., how often payments will be made for the bundled loan) that are determined (e.g., by the payment management module 70 or the machine learning module 170) to be permissible is displayed as a cadence range slider bar 620. The options available extend between weekly payments or monthly payments, and the customer 21 has selected bi-weekly payments. The selection of bi-weekly payments may correspondingly drive an output for the amount of such payments, which may be tied to a payment amount range slider bar 630 and/or a number of payments 640. If the customer 21 wishes to adjust the payment amount by adjusting the payment amount range slider bar 630, doing so may drive the cadence and/or number of payments 640. Similarly, if the customer 21 wishes to adjust the number of payments 640 by typing in a different number (or selecting the number from a slider bar or drop down list of options), the cadence and/or amount may be adjusted accordingly.

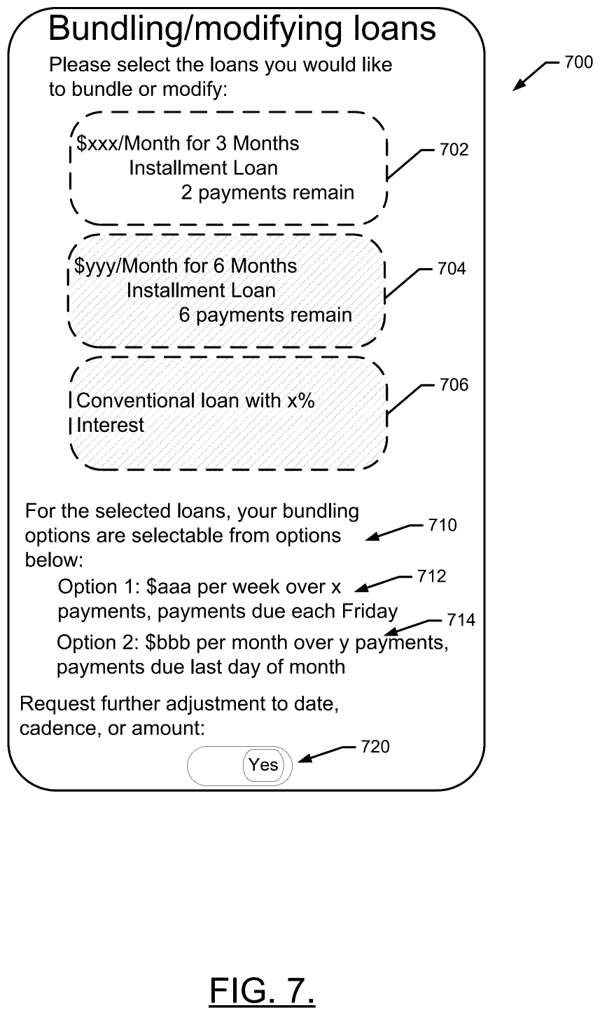

The example of FIG. 6 shows a flexible way to combine or bundle loans and also make specific requests for adjustment of the payment cadence, amount and number of payments (i.e., repayment parameters) for one or more loans. However, it will be appreciated that other modifications are also possible including the date on which payments are made or other such changes. It is also notable that the options for modification can be presented in other formats. In this regard, FIG. 7 illustrates another possible format for providing such options.

FIG. 7 illustrates an alternative example of a web page 700 that may be displayed responsive to selection of the first modification activity 502 of FIG. 5. The web page 700 may be displayed at the client application 22 of the customer 21 through interaction with the payment management module 70 (e.g., with the machine learning module 170), as noted above. The web page 700 displays a loan listing for eligible loans that can be bundled, and the loan listing of this example includes a first loan 702, a second loan 704, and a third loan 706, which are identical to those in the example of FIG. 6, but could alternatively be different. In the depicted example, the customer 21 has indicated selection of the second loan 704 and the third loan 706 for bundling. A bundling options section 710 may then be generated showing selectable options that the customer 21 may employ for submission of details outlining the modification requested.

In this example, a first option 712 for modification includes a selection for a specific payment amount per week over a given number of payments, with payments due each Friday. The amount, the weekly cadence, the number of payments and the payment due date may each be specifically chosen (e.g., by the machine learning module 170) based on information from the user account 160 that indicate likely options to be preferred by this user (i.e., the customer 21). Patterns of activity on the user account 160 may, for example, indicate that Friday is payday for this user, and the amount, cadence and number of payments may also be selected based on past preferences or patterns of behavior that can be gleaned from user activity based on the user account 160, or based on other account activity of users with similar profiles. A second option 714 is also defined to include a different payment amount, over a different number of payments, with a different payment date. These characteristics of the second option 714 may also be determined to be likely options for this user, or users like this user. If further or different adjustments are desired, an adjustment request indicator 720 may be provided to launch screens for defining such adjustments.

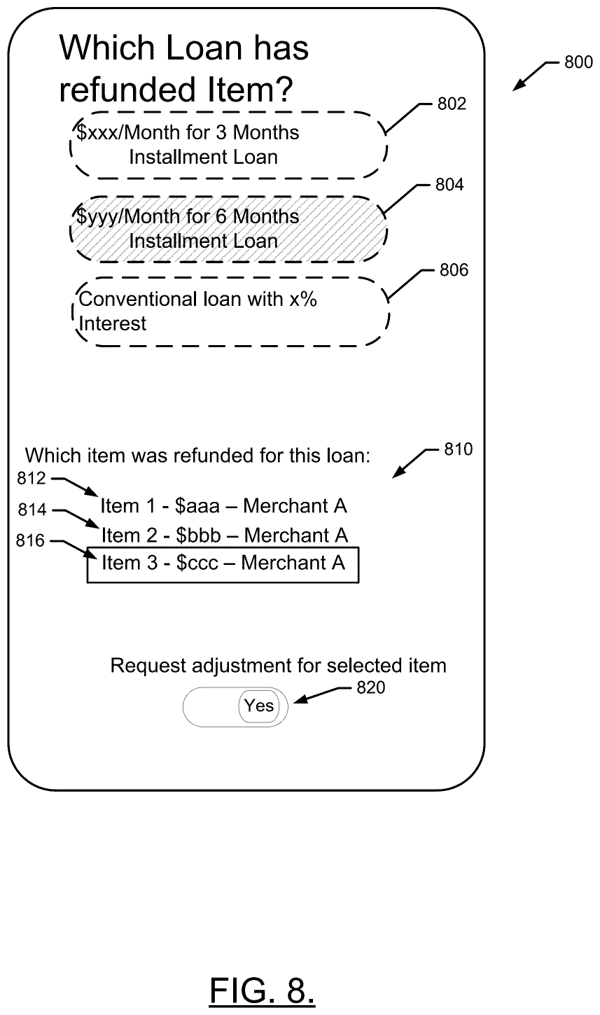

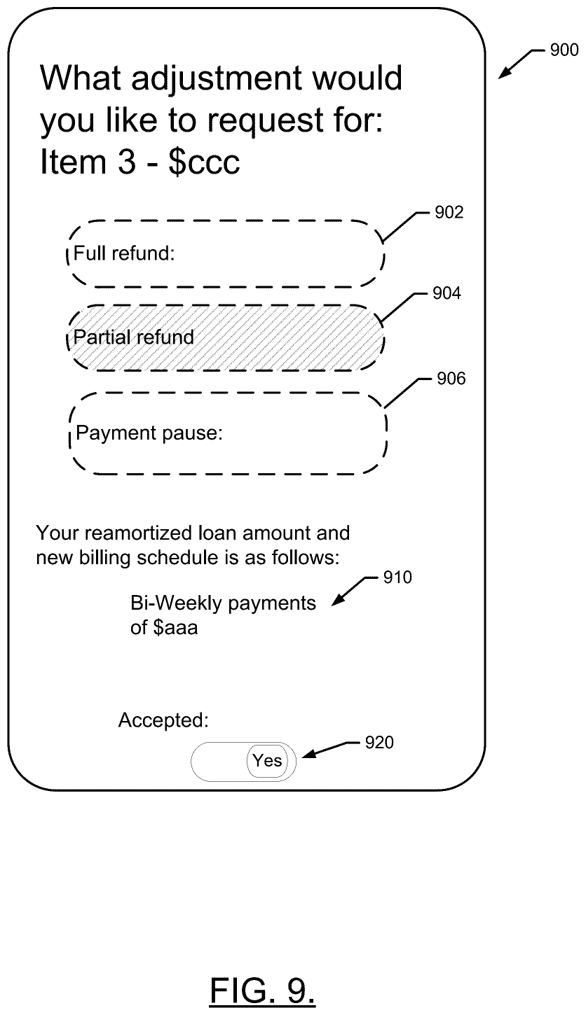

FIG. 8 illustrates a web page 800 that may be displayed responsive to selection of the second modification activity 504 of FIG. 5 (i.e., reporting a refund). However, it should be appreciated that the work flow, and screens and options shown in connection with this example, which will be explained in reference to FIGS. 8 and 9, may be very similar to the work flow and screens and options that may be provided for the third modification activity 506 and the fourth modification activity 508 except that references to refunding activity may be replaced with references to products not yet received/delivered or disputed products.

The web page 800 may be displayed at the client application 22 of the customer 21 through interaction with the payment management module 70 (e.g., with the machine learning module 170), as noted above. The web page 800 displays a loan listing for eligible loans that can be selected for indicating that an item or product/service associated with the corresponding loan has been (or is being) returned for a refund. As noted above, if related to the third or fourth modification activities 506 and 508, the loan listing may be instead associated with loans for which at least one product/service has not yet been received, or to loans for which a product associated therewith is subject to a dispute. The loan listing of this example includes a first loan 802, a second loan 804, and a third loan 806. The highlighting of the second loan 804 indicates that the customer 21 selected the second loan 804 as being the loan with a refunded item. On either the same page (e.g., the web page 800) or a different page, an item listing 810 may be provided to show all items (e.g., along with corresponding prices, merchant identity or other identifying information) that were included in the transaction for which the corresponding loan was originated. In this example, the item listing 810 includes a first item 812, a second item 814 and a third item 816, and the third item 816 has been selected by the customer 21 as having been returned to be refunded.

In some cases, the web page 800 may, responsive to selection of the item being returned for a refund, further provide options for adjustment on the same page. However, in this example, a selector 820 is provided to indicate a request for an adjustment that then links to another page (i.e., web page 900 of FIG. 9) on which the options for adjustment or modification may be listed. Turning to FIG. 9, the web page 900 shows a first adjustment option 902, a second adjustment option 904, and a third adjustment option 906 that are all displayed simultaneously.

The first adjustment option 902 is for a full refund. The full refund may, for example, be applied with respect to the entire loan, if the entire cart or all items involved in a loan-based transaction are being returned. In such a case, any partial repayment previously made by the customer 21 that is attributable to the loan may be refunded to the customer via crediting one of the bank accounts associated with the user account 160. The loan may effectively be paid off by the return of funds by the merchant (or its agent) for the value of the cart or transaction. However, in the meantime, by requesting the first adjustment option 902, the customer 21 may effectively define a pause in repayment and a crediting of the user account 160 to avoid paying for an item the customer 21 no longer has in his/her possession since under normal circumstances the loan would continue to exist with payments required according to the original payment schedule, and with interest (if applicable) also accruing. Thus, the first adjustment option 902 enables the customer 21 to avoid the frustrating situation of paying for the returned item during the processing lag time, which may also create financial hardship for some users.

The second adjustment option 904 (which happens to be selected in this example) is for a partial refund, and may tend to apply to situations where the transaction forming the basis for the selected loan has multiple items, and less than all of the items are returned, meaning the loan will not be fully paid off by any return of funds for the refunded item(s). The partial refund may, for example, be applied with respect to only the returned product(s), or item(s). In such a case, any partial repayment previously made by the customer 21 that is attributable to the returned item(s) may be refunded to the customer via crediting one of the bank accounts associated with the user account 160. However, the remainder of the loan (minus the returned item) will continue to be repaid. The remainder, or modified loan amount, may be recalculated and the loan may resume with reamortization and recalculation of the amounts and schedules of payments. In some cases, the machine learning module 170 may be used to determine most likely preferred options for recalculating amounts and schedules of repayments of the remainder of the loan.

The third adjustment option 906 may be for a payment pause until the refund can be completed. In cases where the web pages 800 and 900 are instead associated with the third modification activity 506 or the fourth modification activity 508 the payment pause may be requested until the products not yet received/delivered have finally received or delivered, or until the dispute is resolved. As noted above, the pause will prevent the customer 21 from having to make a payment on a loan for a product refunded, not received, or subject to a dispute, and may save financial difficulty, but in any case prevent interest accrual and payments from being made during the pause. Once the pause is lifted (e.g., by request of the customer 21, by resolution of the issue, or by expiration of a maximum allowed pause period, the loan terms and repayment schedule may be reinstated. If a refund (full or partial) is executed, or if any other adjustment to the loan amount based on dispute resolution, loan bundling/unbundling, etc. occurs, the loan may be reamortized, and new payment amounts and scheduling options may be either presented for selection, or automatically initiated by the payment management module 70.

In some cases, updated loan information 910 may be presented to the customer 21 on the web page 900. The updated loan information 910 may, in some cases, be an indication of terms that are modified and set in place by the payment management module 70, and the customer 21 may be given a term acceptance option 920. If accepted, the terms may be modified accordingly, and the accepted repayment schedule may be instituted. However, in some cases, the customer 21 may not accept the terms, and a modification may be requested (e.g., as described above).

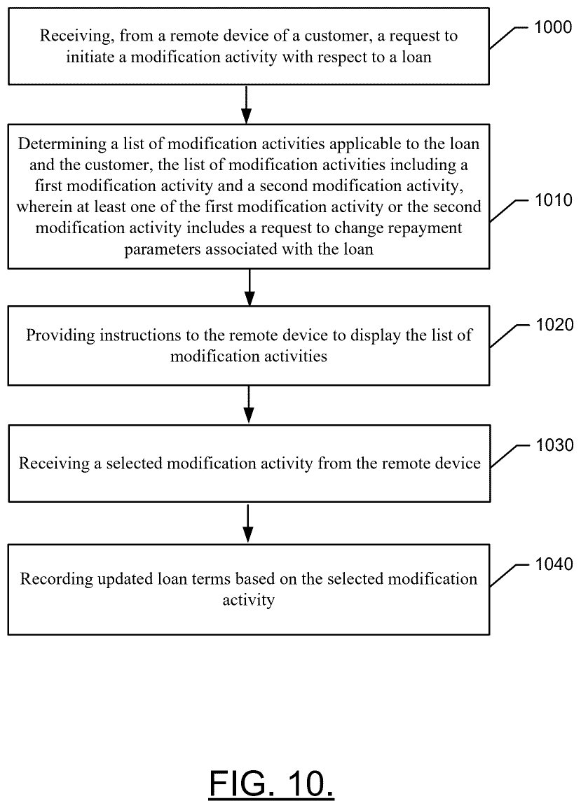

From a technical perspective, the payments platform 50 and/or the payment management module 70 described above may be used to support some or all of the operations described above. As such, the apparatuses described in FIGS. 1 and 2 may be used to facilitate the implementation of several computer program and/or network communication based interactions. As an example, FIG. 10 is a flowchart of a method and program product according to an example embodiment of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of a user terminal (e.g., client 20, application server 42, and/or the like) and executed by a processor in the user terminal. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, a method of providing a user controlled interface in association with loan repayment is shown in FIG. 10. The method may include receiving, from a remote device of a customer, a request to initiate a modification activity with respect to a loan at operation 1000, determining a list of modification activities applicable to the loan and the customer where the list of modification activities includes a first modification activity and a second modification activity, and at least one of the first modification activity or the second modification activity includes a request to change repayment parameters associated with the loan at operation 1010. The method may further include providing instructions to the remote device to display the list of modification activities at operation 1020, receiving a selected modification activity from the remote device at operation 1030, and recording updated loan terms based on the selected modification activity at operation 1040.

In an example embodiment, an apparatus for performing the method of FIG. 10 above may comprise a processor (e.g., the processor 102) or processing circuitry configured to perform some or each of the operations (1000-1040) described above. The processor may, for example, be configured to perform the operations (1000-1040) by performing hardware implemented logical functions, executing stored instructions, or executing algorithms for performing each of the operations. In some embodiments, the processor or processing circuitry may be further configured for additional operations or optional modifications to operations 1000 to 1040.

In some embodiments, the method (and a corresponding apparatus or system configured to perform the operations of the method) may include (or be configured to perform) additional components/modules, optional operations, and/or the components/operations described above may be modified or augmented. Some examples of modifications, optional operations and augmentations are described below. It should be appreciated that the modifications, optional operations and augmentations may each be added alone, or they may be added cumulatively in any desirable combination. In this regard, for example, determining the list of modification activities may include referencing a user account associated with the customer to determine a listing of loans associated with the user account and eligible for modification. In an example embodiment, determining the list of modification activities may further include providing the listing of loans to the remote device, and receiving a selection of a selected loan from the listing of loans, and the list of modification activities may include activities specific to the selected loan. In some cases, responsive to receipt of the selected modification activity, a machine learning module may determine a plurality of modification options to display to the customer based on patterns of activity in a user account associated with the customer. In an example embodiment, one of the modification options may be generated based on an inference regarding a preferred payment schedule based on ACH transfer data associated with the user account. In some cases, one of the modification options may include a request to pause payment on the loan until a dispute with a merchant is resolved or while a refund is processed. In an example embodiment, one of the modification options may include a request to combine loans to determine a single combined payment and schedule. In some cases, one of the modification options may include a request to unbundle at least one item from a list of items associated with the loan, and the at least one item may not yet have been received by the customer, may be subject to a dispute with a merchant, or may be subject to a refund request. In an example embodiment, recording the updated loan terms may include providing a full refund for the at least one item to a user account associated with the customer, and calculating a remaining loan amount, and repayment schedule based on a subtracting the full refund from an original loan amount as adjusted by payments received to date. In some cases, recording the updated loan terms may include providing a partial refund for the at least one item to a user account associated with the customer, and calculating a remaining loan amount, and repayment schedule based on a subtracting the partial refund from an original loan amount as adjusted by payments received to date.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed is:

1. A method for providing an interface for user controlled loan repayment, the method comprising:
receiving, from a remote device of a customer, a request to initiate a modification activity with respect to a loan;
determining a list of modification activities applicable to the loan and the customer, the list of modification activities including a first modification activity and a second modification activity, wherein at least one of the first modification activity or the second modification activity includes a request to change repayment parameters associated with the loan;
providing instructions to the remote device to display the list of modification activities;
receiving a selected modification activity from the remote device; and
recording updated loan terms based on the selected modification activity.

2. The method of claim 1, wherein determining the list of modification activities comprises referencing a user account associated with the customer to determine a listing of loans associated with the user account and eligible for modification.

3. The method of claim 2, wherein determining the list of modification activities further comprises providing the listing of loans to the remote device, and receiving a selection of a selected loan from the listing of loans, and
wherein the list of modification activities includes activities specific to the selected loan.

4. The method of claim 1, wherein responsive to receipt of the selected modification activity, a machine learning module determines a plurality of modification options to display to the customer based on patterns of activity in a user account associated with the customer.

5. The method of claim 4, wherein one of the modification options includes an inference regarding a preferred payment schedule based on ACH transfer data associated with the user account.

6. The method of claim 4, wherein one of the modification options includes a request to pause payment on the loan until a dispute with a merchant is resolved or while a refund is processed.

7. The method of claim 4, wherein one of the modification options includes a request to combine loans to determine a single combined payment and schedule.

8. The method of claim 4, wherein one of the modification options includes a request to unbundle at least one item from a list of items associated with the loan, and
wherein the at least one item has not yet been received by the customer, is subject to a dispute with a merchant, or is subject to a refund request.

9. The method of claim 8, wherein recording the updated loan terms comprises providing a full refund for the at least one item to a user account associated with the customer, and calculating a remaining loan amount, and repayment schedule based on a subtracting the full refund from an original loan amount as adjusted by payments received to date.

10. The method of claim 8, wherein recording the updated loan terms comprises providing a partial refund for the at least one item to a user account associated with the customer, and calculating a remaining loan amount, and repayment schedule based on a subtracting the partial refund from an original loan amount as adjusted by payments received to date.

11. An apparatus for providing an interface for user controlled loan repayment, the apparatus comprising processing circuitry configured to:
receive, from a remote device of a customer, a request to initiate a modification activity with respect to a loan;
determine a list of modification activities applicable to the loan and the customer, the list of modification activities including a first modification activity and a second modification activity, wherein at least one of the first modification activity or the second modification activity includes a request to change repayment parameters associated with the loan;
provide instructions to the remote device to display the list of modification activities;
receive a selected modification activity from the remote device; and
record updated loan terms based on the selected modification activity.

12. The apparatus of claim 11, wherein determining the list of modification activities comprises referencing a user account associated with the customer to determine a listing of loans associated with the user account and eligible for modification.

13. The apparatus of claim 12, wherein determining the list of modification activities further comprises providing the listing of loans to the remote device, and receiving a selection of a selected loan from the listing of loans, and
wherein the list of modification activities includes activities specific to the selected loan.

14. The apparatus of claim 11, wherein responsive to receipt of the selected modification activity, a machine learning module determines a plurality of modification options to display to the customer based on patterns of activity in a user account associated with the customer.

15. The apparatus of claim 14, wherein one of the modification options includes an inference regarding a preferred payment schedule based on ACH transfer data associated with the user account.

16. The apparatus of claim 14, wherein one of the modification options includes a request to pause payment on the loan until a dispute with a merchant is resolved or while a refund is processed.

17. The apparatus of claim 14, wherein one of the modification options includes a request to combine loans to determine a single combined payment and schedule.

18. The apparatus of claim 14, wherein one of the modification options includes a request to unbundle at least one item from a list of items associated with the loan, and
wherein the at least one item has not yet been received by the customer, is subject to a dispute with a merchant, or is subject to a refund request.

19. The apparatus of claim 18, wherein recording the updated loan terms comprises providing a full refund for the at least one item to a user account associated with the customer, and calculating a remaining loan amount, and repayment schedule based on a subtracting the full refund from an original loan amount as adjusted by payments received to date.

20. The apparatus of claim 18, wherein recording the updated loan terms comprises providing a partial refund for the at least one item to a user account associated with the customer, and calculating a remaining loan amount, and repayment schedule based on a subtracting the partial refund from an original loan amount as adjusted by payments received to date.
